(19) United States
(12) Patent Application Publication
(10) Pub. No.: US 2023/0145804 A1
(43) Pub. Date: May 11, 2023

(54) SYSTEM AND METHOD FOR AUTOMATED IMAGE REVIEWING

(71) Applicant: Schlumberger Technology Corporation, Sugar Land, TX (US)

(72) Inventors: Jagdish Idhate, Pune (IN); Vijay Kumar, Pune (IN)

(21) Appl. No.: 17/906,889

(22) PCT Filed: Mar. 25, 2021
(86) PCT No.: PCT/US2021/024128

§ 371 Date: Sep. 21, 2022

Related U.S. Application Data
(60) Provisional application No. 62/994,702, filed on Mar. 25, 2020.

(51) Int. Cl. G06Q 10/101; G06F 8/61; G06F 11/36

(52) U.S. Cl. CPC G06Q 10/101; G06F 8/63; G06F 11/3688; G06Q 2230/00

(57) ABSTRACT

A method for automated image reviewing involves obtaining an image to be reviewed, identifying a multitude of stakeholders associated with the image, and iteratively performing a review of the image by the multitude of stakeholders to obtain an approval of the image. The iteratively performing the review includes sequentially obtaining a vote on the image from each stakeholder of the multitude of stakeholders and discontinuing the sequential obtaining of the vote if one of the multitude of stakeholders votes o reject the image. The method further involves releasing the image for deployment if the vote of each stakeholder in the plurality of stakeholders approves the image.

### CROSS REFERENCE PARAGRAPH

This application claims the benefit of U.S. Provisional Application No. 62/994,702, entitled “AUTOMATED IMAGE CREATION PROCESS,” filed Mar. 25, 2020, the disclosure of which is hereby incorporated herein by reference.

### BACKGROUND

Numerous software components, e.g., applications, plugins, drivers, etc., may be packaged into a software image. The software components may be provided by different contributors, e.g., individual software developers, software development teams, third party software providers, etc. Each of the software components in the software image may have unknown flaws. Further, there may be unknown interaction between different software components in the software image. A testing of the software components in the software image may be performed prior to releasing the software image, to detect possible flaws.

### SUMMARY

In general, in one aspect, one or more embodiments relate to an automated image reviewing comprising: obtaining an image to be reviewed; identifying a plurality of stakeholders associated with the image; iteratively performing a review of the image by the plurality of stakeholders to obtain an approval of the image by: sequentially obtaining a vote on the image from each stakeholder of the plurality of stakeholders; discontinuing the sequential obtaining of the vote if one of the plurality of stakeholders votes to reject the image; and releasing the image for deployment if the vote of each stakeholder in the plurality of stakeholders approves the image.

### BRIEF DESCRIPTION OF DRAWINGS

FIG. 1 shows a diagram of a field in accordance with one or more embodiments.

FIG. 2 shows a diagram of a system in accordance with one or more embodiments.

FIG. 3.1 and FIG. 3.2 show flowcharts in accordance with one or more embodiments.

FIG. 4 shows an example pipeline for image review in accordance with one or more embodiments.

FIG. 5 shows an example wiki in accordance with one or more embodiments.

FIG. 6.1 and FIG. 6.2 show diagrams of computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

The following detailed description is merely an example and is not intended to limit the disclosed technology or the application and uses of the disclosed technology. Furthermore, there is no intention to be bound by any expressed or implied theory presented in the preceding technical field, background, or the following detailed description.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.)

may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments are directed to reviewing and releasing images. An image (also referred to as a software image) is executable code generated from software components.

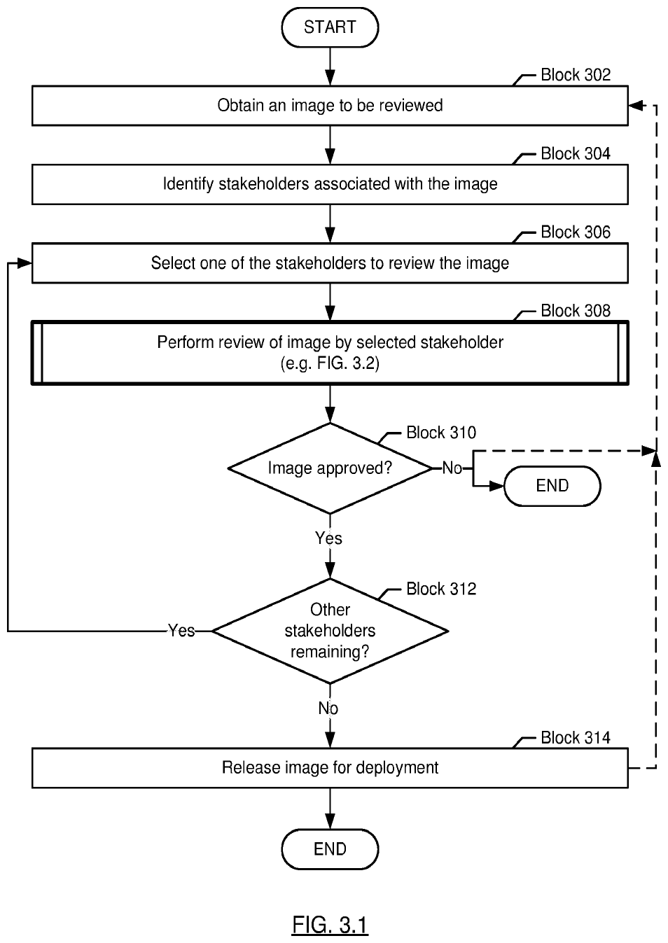

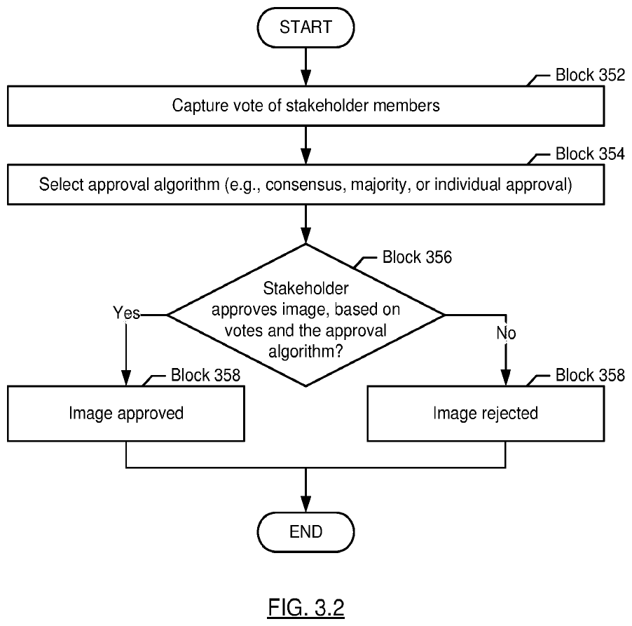

An image to be deployed in a deployment environment (e.g., a deployment environment of a customer or any other type of user) may be selected for release by applying a decision-making algorithm to stakeholders of the image. Each of the stakeholders may be responsible for one or more software components included in the image. Examples of decision-making algorithms may include majority approval, consensus approval, etc. by the stakeholders. Once the image has been created, a series of tests is performed on the image by the stakeholders and/or associates of the stakeholders who may vote on whether to approve the image for release. If the image passes the tests performed by a stakeholder, the stakeholder may vote to approve the image for release. If the image fails one or more of the tests performed by the stakeholder, the stakeholder may vote against approving the image for release. Eventually, a decision regarding the release of the image for deployment may be made by applying the decision-making algorithm to the votes by the stakeholders of the image. A more detailed description of the image, the software components, the stakeholders, and the decision-making algorithm is provided below in reference to FIGS. 2, 3.1, and 3.2.

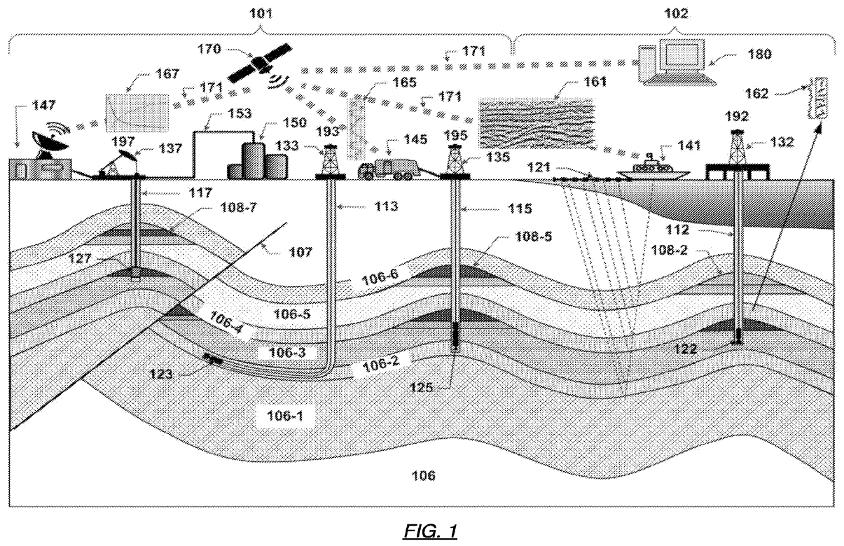

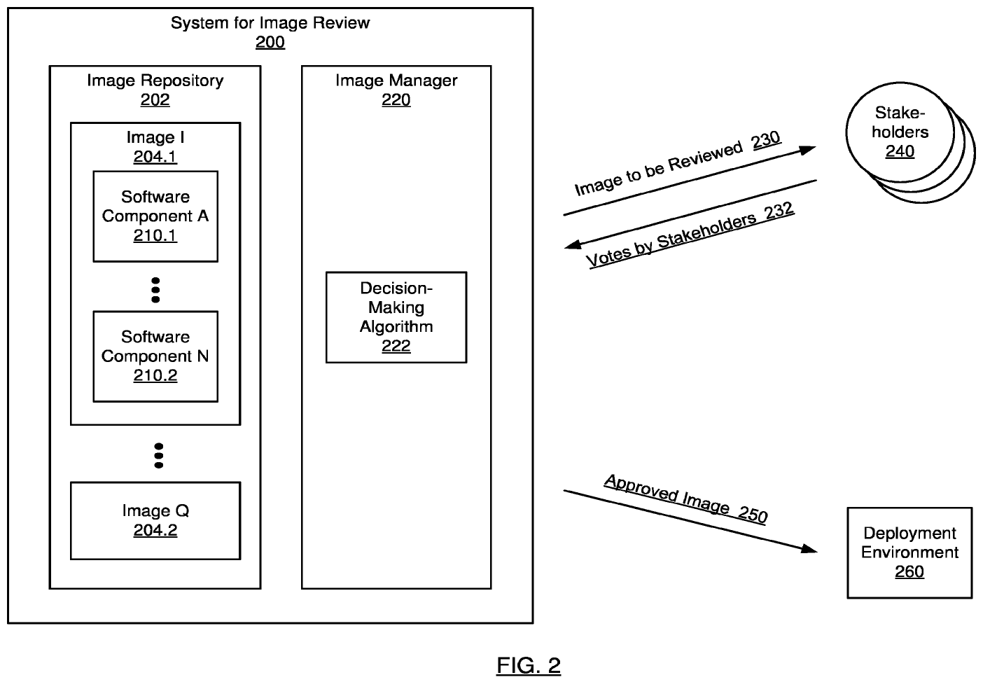

FIG. 1 depicts a schematic view, partially in cross section, of an onshore field (101) and an offshore field (102) in which one or more embodiments may be implemented. In one or more embodiments, one or more of the modules and elements shown in FIG. 1 may be omitted, repeated, and/or substituted. Accordingly, embodiments should not be considered limited to the specific arrangement of modules shown in FIG. 1.

As shown in FIG. 1, the fields (101), (102) include a geologic sedimentary basin (106), wellsite systems (192), (193), (195), (197), wellbores (112), (113), (115), (117), data acquisition tools (121), (123), (125), (127), surface units (141), (145), (147), well rigs (132), (133), (135), production equipment (137), surface storage tanks (150), production pipelines (153), and an E&P computer system (180) connected to the data acquisition tools (121), (123), (125), (127), through communication links (171) managed by a communication relay (170).

The geologic sedimentary basin (106) contains subterranean formations. As shown in FIG. 1, the subterranean formations may include several geological layers (106-1 through 106-6). As shown, the formation may include a basement layer (106-1), one or more shale layers (106-2, 106-4, 106-6), a limestone layer (106-3), a sandstone layer (106-5), and any other geological layer. A fault plane (107) may extend through the formations. In particular, the geologic sedimentary basin includes rock formations and may include at least one reservoir including fluids, for example the sandstone layer (106-5). In one or more embodiments, the rock formations include at least one seal rock, for example, the shale layer (106-6), which may act as a top seal. In one or more embodiments, the rock formations may include at least one source rock, for example the shale layer (106-4), which may act as a hydrocarbon generation source. The geologic sedimentary basin (106) may further contain hydrocarbon or other fluids accumulations associated with certain features of the subsurface formations. For example, accumulations (108-2), (108-5), and (108-7) associated with structural high areas of the reservoir layer (106-5) and containing gas, oil, water, or any combination of these fluids.

In one or more embodiments, data acquisition tools (121), (123), (125), and (127), are positioned at various locations along the field (101) or field (102) for collecting data from the subterranean formations of the geologic sedimentary basin (106), referred to as survey or logging operations. In particular, various data acquisition tools are adapted to measure the formation and detect the physical properties of the rocks, subsurface formations, fluids contained within the rock matrix and the geological structures of the formation. For example, data plots (161), (162), (165), and (167) are depicted along the fields (101) and (102) to demonstrate the data generated by the data acquisition tools. Specifically, the static data plot (161) is a seismic two-way response time. Static data plot (162) is core sample data measured from a core sample of any of subterranean formations (106-1 to 106-6). Static data plot (165) is a logging trace, referred to as a well log. Production decline curve or graph (167) is a dynamic data plot of the fluid flow rate over time. Other data may also be collected, such as historical data, analyst user inputs, economic information, and/or other measurement data and other parameters of interest.

The acquisition of data shown in FIG. 1 may be performed at various stages of planning a well. For example, during early exploration stages, seismic data (161) may be gathered from the surface to identify possible locations of hydrocarbons. The seismic data may be gathered using a seismic source that generates a controlled amount of seismic energy. In other words, the seismic source and corresponding sensors (121) are an example of a data acquisition tool. An example of seismic data acquisition tool is a seismic acquisition vessel (141) that generates and sends seismic waves below the surface of the earth. Sensors (121) and other equipment located at the field may include functionality to detect the resulting raw seismic signal and transmit raw seismic data to a surface unit (141). The resulting raw seismic data may include effects of seismic wave reflecting from the subterranean formations (106-1 to 106-6).

After gathering the seismic data and analyzing the seismic data, additional data acquisition tools may be employed to gather additional data. Data acquisition may be performed at various stages in the process. The data acquisition and corresponding analysis may be used to determine where and how to perform drilling, production, and completion operations to gather downhole hydrocarbons from the field. Generally, survey operations, wellbore operations and production operations are referred to as field operations of the field (101) or (102). These field operations may be performed as directed by the surface units (141), (145), (147). For example, the field operation equipment may be controlled by a field operation control signal that is sent from the surface unit.

Further as shown in FIG. 1, the fields (101) and (102) include one or more wellsite systems (192), (193), (195), and (197). A wellsite system is associated with a rig or a production equipment, a wellbore, and other wellsite equipment configured to perform wellbore operations, such as logging, drilling, fracturing, production, or other applicable operations. For example, the wellsite system (192) is associated with a rig (132), a wellbore (112), and drilling equipment to perform drilling operation (122). In one or more embodiments, a wellsite system may be connected to a production equipment. For example, the well system (197) is connected to the surface storage tank (150) through the fluids transport pipeline

In one or more embodiments, the surface units (141), (145), and (147), are operatively coupled to the data acquisition tools (121), (123), (125), (127), and/or the wellsite systems (192), (193), (195), and (197). In particular, the surface unit is configured to send commands to the data acquisition tools and/or the wellsite systems and to receive data therefrom. In one or more embodiments, the surface units may be located at the wellsite system and/or remote locations. The surface units may be provided with computer facilities (e.g., an E&P computer system) for receiving, storing, processing, and/or analyzing data from the data acquisition tools, the wellsite systems, and/or other parts of the field (101) or (102). The surface unit may also be provided with, or have functionality for actuating, mechanisms of the wellsite system components. The surface unit may then send command signals to the wellsite system components in response to data received, stored, processed, and/or analyzed, for example, to control and/or optimize various field operations described above.

In one or more embodiments, the surface units (141), (145), and (147) are communicatively coupled to the E&P computer system (180) via the communication links (171). In one or more embodiments, the communication between the surface units and the E&P computer system may be managed through a communication relay (170). For example, a satellite, tower antenna or any other type of communication relay may be used to gather data from multiple surface units and transfer the data to a remote E&P computer system for further analysis. Generally, the E&P computer system is configured to analyze, model, control, optimize, or perform management tasks of the aforementioned field operations based on the data provided from the surface unit. In one or more embodiments, the E&P computer system (180) is provided with functionality for manipulating and analyzing the data, such as analyzing seismic data to determine locations of hydrocarbons in the geologic sedimentary basin (106) or performing simulation, planning, and optimization of E&P operations of the wellsite system. In one or more embodiments, the results generated by the E&P computer system may be displayed for user to view the results in a two-dimensional (2D) display, three-dimensional (3D) display, or other suitable displays. Although the surface units are shown as separate from the E&P computer system in FIG. 1, in other examples, the surface unit and the E&P computer system may also be combined.

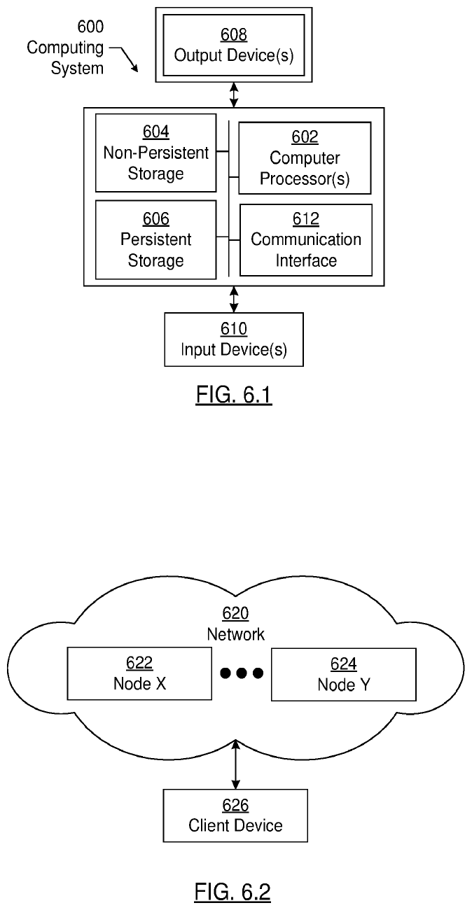

In one or more embodiments, the E&P computer system (180) is implemented by an E&P services provider by deploying software components with a cloud-based infrastructure. As an example, the software components may include a web application that is implemented and deployed on the cloud and is accessible from a browser. Users (e.g., external clients of third parties and internal clients of the E&P services provider) may log into the applications and execute the functionality provided by the applications to analyze and interpret data, including the data from the surface units (141), (145), and (147). The E&P computer system and/or surface unit may correspond to a computing system, such as the computing system shown in FIGS. 6.1 and 6.2 and described below. The software components may be provided in the format of an image. In one or more embodiments, the image, once released for deployment, has undergone a review process as subsequently described.

FIG. 2 is an example diagram of a system for image review (200) in accordance with one or more embodiments of the disclosure. The system may be implemented on a computing system, e.g., as shown in FIGS. 6.1 and 6.2. For example, the computing system may be the E&P computing system described in reference to FIG. 1. The system (200) may include or may have access to an image repository (202). The system (200) may further include an image manager (220).

The image repository may be any type of storage capable of holding one or more images (204.1, 204.2). The image repository may be located, for example, on one or more hard drives, in a cloud storage, etc.

An image (204.1, 204.2) is executable code generated from any number of software components (210.1, 210.2). A software component may be a collection of source code. A software component may include statements written in a programming language, or intermediate representation (e.g., byte code). A software component may be transformed by a compiler into binary machine code. Compiled machine code of the software component may be executed by a processor (e.g., computer processor (602)). In one or more embodiments, a software component may be any collection of object code (e.g., machine code generated by a compiler) or another form of the software component. Software components may include, but are not limited to software applications, plugins to extend functionalities of software applications, and drivers for hardware and/or software resources. An image (204.1) may be generated by compiling the software components (210.1, 210.2). Different images may include different software components. Different images may also include different versions of the same software components. The image may also include or may be accompanied by a documentation of one or more of the software components in the image. The documentation may describe functionality and/or use of the software components. The documentation, in one or more embodiments, identifies the stakeholders associated with the software components, e.g., developers, decision makers, users, etc., associated with the software components.

The image manager (220) may include a set of instructions stored on a computer readable medium comprising instructions that, when executed may be used to review images (204.1, 204.2). Broadly speaking, when an image is generated, whether the software components in the image are functioning as intended may be unknown. For example, a software component may have unknown flaws, unknown interactions may exist between different software components in the image, etc. In one or more embodiments, the image manager (220) facilitates the review and testing of the image. The output of the image manager (220) may be used to decide whether the image is ready to be released in a deployment environment (260). The image may then be deployed (e.g., executed) in the deployment environment (260). In one or more embodiments, a deployment environment may be a computing system (e.g., computing system (600)), including a virtual machine, in which one or more software components of the image are deployed and executed. The deployment environment may be associated with a customer and/or user of one or more of the software components in the image. For example, the deployment environment may be an exploration and/or production environment as described in FIG. 1.

In one or more embodiments, the review and testing of an image is performed by stakeholders (240). In one or more embodiments, a software component (210) in an image to be reviewed (230) may be associated with one or more stakeholders (240). The stakeholders (240) may be individuals and/or groups responsible for the development, maintenance, and/or distribution, etc. of the software component (210). Each of the stakeholders may vote on the image to be reviewed (230) to decide whether to approve or reject the image. To make the decision regarding approval or rejection, the stakeholder may perform any kind of test on the image, to detect whether defects, undesired interactions between different software components or other unexpected behaviors exist. The tests performed by the stakeholder may also evaluate performance, reliability, accuracy, user-friendliness, etc. The testing by the stakeholder may be performed in a stakeholder environment, e.g., in a testing environment that mimics the deployment environment (260). There may be different stakeholder environments for different purposes. Examples of stakeholder environments include a development environment, a unit testing environment, a system integration environment, a user acceptance environment, etc.

To get an image (204.1) evaluated by a stakeholder, the image manager (220) may provide one of the images (204.1, 204.2) as an image to be reviewed (230) to a stakeholder (240). If the stakeholder includes a group of stakeholder members (e.g., a development team), the image to be reviewed (230) may be sent to at least some of the stakeholder members. Based on the test results, the stakeholder (240) may respond to the image manager with a vote (232). In a group of stakeholder members, each of the stakeholder members may respond with a vote. The vote may indicate whether the image (230) is accepted or rejected by the stakeholder (240). In one or more embodiments, the image (230) may be evaluated by multiple or many stakeholders. Accordingly, the process of providing the image to be reviewed (230) to a stakeholder (240) and receiving a vote or votes from the stakeholder (240) may be repeated. The decision-making algorithm (222) may subsequently process the votes (232) to decide whether the image (230) may be released for deployment as an approved image (250) in a deployment environment (260), as further discussed below in reference to the flowcharts of FIGS. 3.1 and 3.2.

For example, the decision-making algorithm (222) may perform the following operations. For a stakeholder (240) that includes multiple stakeholder members (e.g., a team of software developers responsible for a particular software component of the image to be reviewed), each of the stakeholder members may submit an accept/reject vote. The decision-making algorithm (222) may subsequently evaluate the votes using, for example, (a) a majority vote, where a decision to approve is based on the majority of stakeholder members voting to approve the image; (b) a consensus vote, where a decision to approve is based on an unanimous approval by the stakeholders; (c) a minimum approval vote, where a decision to approve is based on a threshold number of stakeholder members voting to approve the image; and (d) a requisite approval where a decision to approve is made by one or more select stakeholder members.

In one or more embodiments, once the image to be reviewed has been approved by one stakeholder (based on the evaluation of the vote(s) by the decision-making algorithm (222)), the image manger (220) may initiate the review by another stakeholder. The process may continue until the various stakeholders associated with the image have approved the image. The image may be discarded if a unanimous approval by the stakeholders is not obtained. Therefore, the approval process, in one or more embodiments, is performed in an iterative manner, with a different stakeholder or different stakeholders being involved in the approval, with each iteration. For example, initially, the image may be reviewed by a software development team responsible for the software components of the image. The initial review may be performed in a development environment. Next, in a pre-release stage, the image may be reviewed by internal members of a software review team that may test the image in a simulated production environment. Subsequently, in a beta-release stage, the image may be reviewed by a set of select customers, e.g., in an environment designed to evaluate customer acceptance. Finally, the image may be reviewed by a larger group of customers or the general customers in an environment reflecting the actual use of the image by the customers in production environments. As a result, with each iteration, larger groups of stakeholder members may get involved in the review process.

While FIG. 2 shows configurations of components, other configurations may be used without departing from the scope of the disclosure. For example, various components may be combined to create a single component. As another example, the functionality performed by a single component may be performed by two or more components.

FIGS. 3.1 and 3.2 show flowcharts in accordance with one or more embodiments. One or more of the steps in FIGS. 3.1 and 3.2 may be performed by the components (e.g., the image manager (220)) of the system (200)) discussed above in reference to FIG. 2. While the various steps in these flowchart are presented and described sequentially, one of ordinary skill will appreciate that at least some of the blocks may be executed in different orders, may be combined or omitted, and at least some of the blocks may be executed in parallel. Additional steps may further be performed. Accordingly, the scope of the disclosure should not be considered limited to the specific arrangement of steps shown in FIGS. 3.1 and 3.2.

The flowchart of FIG. 3.1 depicts a method for an automated reviewing of an image, in accordance with one or more embodiments.

In Block 302, an image to be reviewed is obtained. The image may be an image obtained from an image repository, or it may be obtained in any other way. The image to be reviewed may be a new image that includes newly developed software components, or the image to be reviewed may be an upgraded version of an image that was previously deployed.

In Block 304, the stakeholders associated with the image are identified. The image may include a documentation that identifies the stakeholders, for example by name, email address, or any other identifier. Stakeholders may be identified in other manners, without departing from the disclosure. If a stakeholder is formed by a team (e.g., a software development team or a cloud engineering team), the stakeholder members may be identified.

The identification of the stakeholders may establish an order of the stakeholders. Specifically, the subsequently described steps may be performed in an iterative manner, based on the order of the stakeholders. The order of the stakeholders may be established based on the roles of the stakeholders in the approval process. Assume, for example, that there are three stakeholders: a set of pilot customers who review new software images prior to the release to general customers; a software development team; and a quality assurance team. The order of the stakeholders in the process of reviewing the image would be as follows: (i) software development team; (ii) quality assurance team; and (iii) pilot customers. The order ensures that the scope of the review increases through the iterations. First, a relatively limited number of software developers conducts a review with a limited scope (e.g., checking for software errors). If that review is completed with an approval of the image, the image is passed on to the quality assurance team. The quality assurance team may have more members and may perform a review with a broader scope (e.g., examining user experience, interactions, more error checking). Finally, the pilot customers may review the image in an actual or simulated production environment with exposure to real-world factors affecting the performance of the software components in the image in many ways.

In Block 306, one of the stakeholders is selected for a review of the image.

With Blocks 306-312 being executed in a loop to implement the iterative approval of the image, the stakeholder may be selected according to a particular order, e.g., as previously discussed.

In Block 308, a review of the image by the selected stakeholder is performed.

The stakeholder may perform one or more tests to determine whether the image should be approved or rejected. The tests that are performed may be specific to the stakeholder or even to the stakeholder member. Each test may evaluate different aspects. For example, one test may be designed to identify interactions between software components in the image. Another test may be designed to evaluate the performance of one or more of the software components, etc. Each of the tests may provide test results. After completing one or more tests, a stakeholder may submit a vote to indicate whether the image is approved or rejected, based on the test. In Block 308, the vote is received. If the stakeholder includes multiple stakeholder members, multiple votes may be received. In one or more embodiments, the test results are automatically analyzed to determine whether the test results satisfy a passing criterion. For example, the passing criterion may be that the image to pass a specific percentage of tests. Alternatively, the passing criterion may be that the image passes one or more high priority tests. If the image fails a test, then a software defect tracking process (e.g., to debug and/or repair one or more applications included in the image responsible for the failure) may be automatically initiated. In one embodiment, if the image passes a test, a vote to approve the image is automatically submitted, and a vote to reject the image is automatically submitted if the image fails the test. In such an embodiment, no human involvement by the stakeholder member is performed to submit the vote. In one embodiment, the stakeholder member may choose to manually submit a vote. In one embodiment, in a hybrid approach, the stakeholder member may manually vote if the image fails the test, but a vote may be automatically submitted if the image passes the test.

After the receiving of the votes, the votes may be processed to determine whether the selected stakeholder approves or rejects the image. The receiving and processing of the votes is described below, in reference to FIG. 3.2.

In Block 310, if the selected stakeholder approved the image, the execution of the method may proceed with Block 312. If the selected stakeholder rejected the image, the execution of the method may terminate, or alternatively, the execution of the method may proceed with Block 302 by obtaining a different image, e.g., a revise image. Accordingly, if one stakeholder rejects the image, the iterative approval of the image, stakeholder-by-stakeholder, may be discontinued, and the image may not be released for deployment. However, if an image fails to get approved, the approval process may be restarted with a different image. Assume, for example, that the stakeholder reviewing the image has detected a defect and, therefore, rejects the image. A revised image may address the defect, based on bug reports generated when a test has failed, and may subsequently enter the review process.

In Block 312, if other stakeholders are remaining, the execution of the method may proceed with Block 306 to select another stakeholder to obtain approval of the image. If no other stakeholders are remaining, the execution of the method may proceed with Block 314.

In Block 314, the image may be released for deployment. The image may be replicated for distribution to multiple deployment environments. Additional tasks may be performed. For example, a documentation accompanying the release of the image may be generated. The documentation may include automatically generated release notes based on the differences (e.g., by applying a code difference tool) between the image just released for deployment and a previously released version of the image. As another example, stakeholder-provided release notes and/or a developer documentation, e.g., based on templates to be completed by the developer(s), may be added to the documentation. The generated documentation may be in the format of a wiki and may be based on a wiki template.

The flowchart of FIG. 3.2 depicts a method for performing a review of an image by a stakeholder, in accordance with one or more embodiments.

In Block 352, the vote of the stakeholder is captured. Multiple stakeholder members may vote, and each of the votes may be captured. For example, the stakeholder members may receive an email request (or any other type of request) to review and approve the image. To vote, the stakeholder members may reply to the email request. A time limit (e.g., a due date) may be set for the vote. The vote of each stakeholder member may be binary (e.g., either “approved” or “rejected”).

Once the time limit elapses, the votes may be evaluated by an approval algorithm In Block 354, an approval algorithm, determining how the votes are evaluated, is selected. For example, a majority vote algorithm, a consensus vote algorithm, a minimum approval vote algorithm, or a requisite approval vote algorithm, as previously described, may be selected. The selection may be specific to the stakeholder, and different approval algorithms may, thus, be used for different stakeholders.

In Block 356, the approval algorithm is executed on the votes to determine whether the stakeholder approves (Block 358) or rejects (Block 360) the image.

The execution of the method for an automated reviewing of an image, as described in reference to FIGS. 3.1 and 3.2, may be initiated by various triggers. For example, there may be a daily image creation trigger, or the execution may be manually triggered by an operator. Alternatively, the execution may be triggered as soon as an image becomes available.

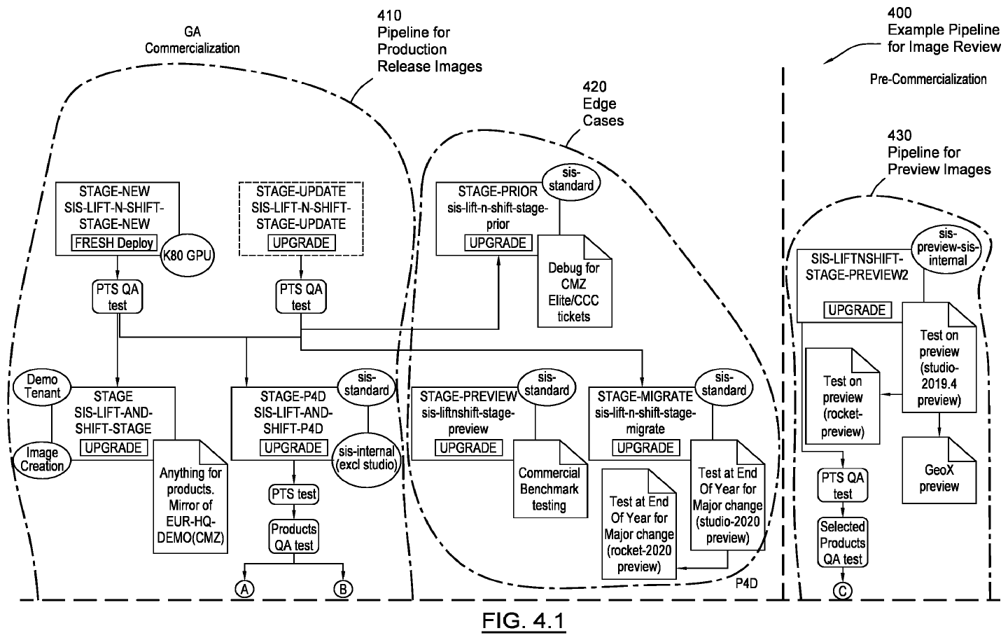

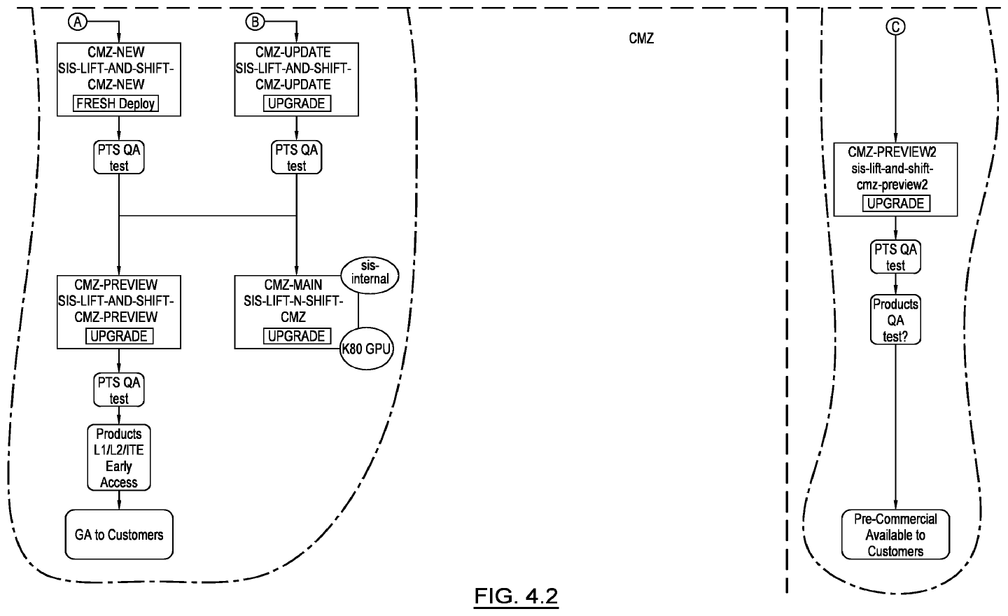

FIG. 4 shows an example pipeline for image review (400), in accordance with one or more embodiments. The example pipeline illustrates the repeated execution of the methods of FIGS. 3.1 and 3.2 in a process that may result in the release of an image. The example (400) is structured into four quadrants.

On the left side (left quadrants), from top to bottom, a pipeline for production release images (410) is shown. The pipeline for production release images performs different review operations (labeled either “FRESH deploy” or “UPGRADE”), depending on whether the image to be reviewed is to be deployed in a new or in an existing environment. Additional steps may be performed for deployment in existing environment to ensure seamless operation with existing data, to perform a data migration, etc. These steps may be skipped when the deployment is in a new environment. To obtain an image to be released for deployment, the image undergoes various reviews in a pre-production environment (upper left quadrant), and eventually in a production environment (lower left quadrant). As the review of an image progresses from top to bottom of FIG. 4, an increasing number of stakeholders are involved in the image review process—initially limited to developer teams, while eventually also involving customers or select customers. The pipeline for production images (410) may support various edge cases (420), e.g., an edge case for benchmark testing, an edge case for debugging when a review of the image indicated a bug, and an edge case for more extensive testing for major testing, e.g., of annual image releases.

On the right side (right quadrants), from top to bottom, a pipeline for preview images (430) is shown. To complete the review of an image, the image undergoes one or more reviews in a pre-production environment (upper right quadrant), and in a production environment (lower right quadrant). The pipeline for preview images (430) may be executed at frequencies higher than the pipeline for production release images (410). For example, the pipeline for preview images (430) may be executed on a daily or weekly basis to review incrementally updated software components in a software image.

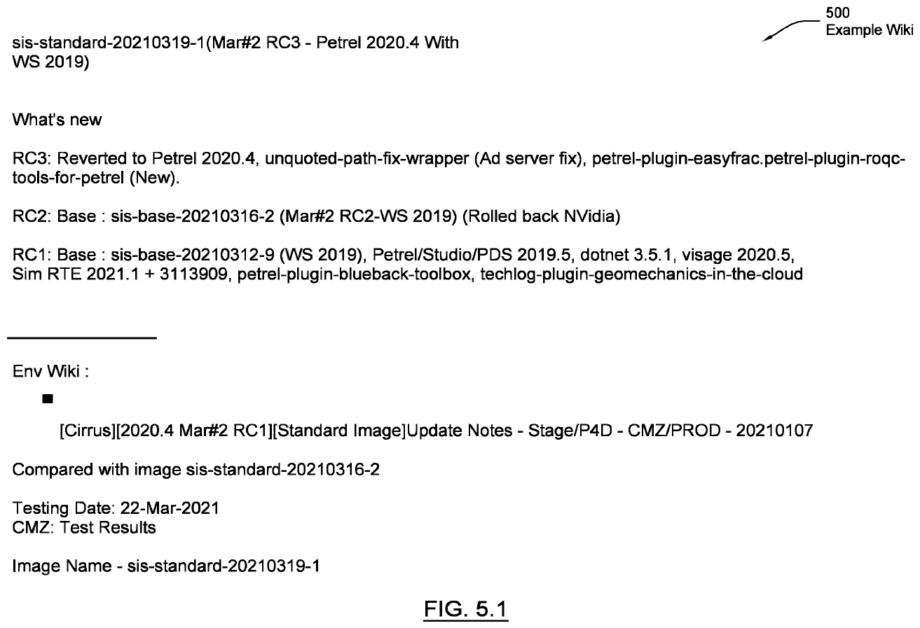

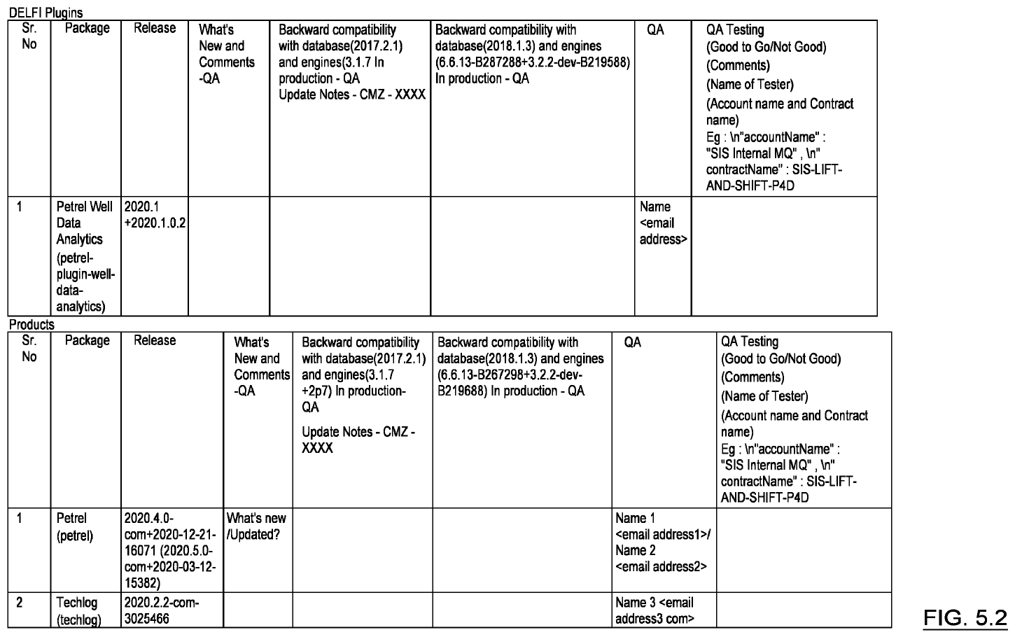

FIG. 5 shows an example wiki, in accordance with one or more embodiments of the disclosure. The example wiki (500) may have been generated during the execution of the steps described in FIGS. 3.1 and 3.2. The wiki (500) is for an image “sis-standard-20210319-1”, and may have been generated by a wiki template that includes various sections such as “What's New” and any number of sections for plugins (here: “DELFI Plugins”) and products (here: “Products”), depending on the content of the image. An entry may be available for each of the software components of the image. An entry may name a package that includes the software component (“Package”), a release number or date (“Release”), a description of the novelties over a previous version (“What's New and Comments—QA”), sections indicating backwards compatibility with databases and engines (in the example, a review of backwards compatibility for two versions of databases and engines is shown), an identification of the stakeholders (“QA”), and comments by the stakeholders (“QA Testing”). At least some of the content in the wiki may be automatically entered as the methods of FIGS. 3.1 and 3.2 are performed, and some of the content may be manually entered by the stakeholders. The wiki may further include links to additional documents.

Embodiments of the disclosure enable an automated reviewing of images.

Unlike a conventional review of software components, prior to generating an image, the review of the image after generation of the image enables the detection of additional flaws that would otherwise not be visible. Such flaws include, for example, interactions between different software components in the image.

Embodiments of the disclosure are suitable for the review of images that involve numerous stakeholders, and where the stakeholders may be involved at different times of the review, where the stakeholders may be geographically distributed, etc. The configurability of the decision-making algorithm allows for flexibility, with the decision-making being individually configurable for each stakeholder. The decision-making algorithm may be dynamically updated at any time. For example, depending on the urgency of an image release, consensus voting may be the norm, but when less time is available, majority voting may be used, and in a particularly urgent situation, a single person may provide an approval. Similarly, for a major release, a consensus vote may be required, whereas for a minor release, a majority vote may be sufficient.

Embodiments of the disclosure further enable an independent, fact-based review of images by eliminating the need for meetings and discussions, where people tend to influence each other.

Embodiments of the disclosure may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6.1, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities that implement the features and elements of the disclosure.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (600) in FIG. 6.1 may be connected to or be a part of a network. For example, as shown in FIG. 6.2, the network (620) may include multiple nodes (e.g., node X (622), node Y (624)). Each node may correspond to a computing system, such as the computing system shown in FIG. 6.1, or a group of nodes combined may correspond to the computing system shown in FIG. 6.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (600) may be located at a remote location and connected to the other elements over a network.

Although not shown in FIG. 6.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6.1. Further, the client device (626) may include and/or perform at least a portion of one or more embodiments of the disclosure.

The computing system or group of computing systems described in FIGS. 6.1 and 6.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 6.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6.1, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B involves comparing the first element of vector A with the first element of vector B, the second element of vector A with the second element of vector B, etc. In one or more embodiments, if A and B are strings, the binary values of the strings may be compared.

The computing system in FIG. 6.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g. join, full join, count, average, etc.), sorts (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents a few examples of functions performed by the computing system of FIG. 6.1 and the nodes and/or client device in FIG. 6.2. Other functions may be performed using one or more embodiments of the disclosure.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited by the claims.

What is claimed is:

1. A method comprising:
obtaining an image to be reviewed;
identifying a plurality of stakeholders associated with the image;
iteratively performing a review of the image by the plurality of stakeholders to obtain an approval of the image by:
sequentially obtaining a vote on the image from each stakeholder of the plurality of stakeholders;
discontinuing the sequential obtaining of the vote if one of the plurality of stakeholders votes to reject the image; and
releasing the image for deployment if the vote of each stakeholder in the plurality of stakeholders approves the image.

2. The method of claim 1,
wherein at least one of the plurality of stakeholders comprises multiple stakeholder members.

3. The method of claim 2,
wherein the vote of the at least on stakeholder is one selected from the group consisting of a majority vote, a consensus vote, a minimum approval vote, and a requisite approval vote by the multiple stakeholder members.

4. The method of claim 1, wherein the vote is based on a testing of the image.

5. The method of claim 4, wherein the vote is automatically submitted after the testing of the image, without human involvement.

6. The method of claim 4,
wherein the vote is automatically submitted after the testing of the image, without human involvement, if the image passes the test, and
wherein the vote is manually submitted after the testing of the image, if the image fails the test.

7. The method of claim 1, further comprising generating a documentation of the image, the documentation included in the image released for deployment.

8. A system comprising:
a computer processor; and
instructions executing on the computer processor causing the system to:
obtain an image to be reviewed;
identify a plurality of stakeholders associated with the image;
iteratively perform a review of the image by the plurality of stakeholders to obtain an approval of the image by:
sequentially obtaining a vote on the image from each stakeholder of the plurality of stakeholders;
discontinuing the sequential obtaining of the vote if one of the plurality of stakeholders votes to reject the image; and
release the image for deployment if the vote of each stakeholder in the plurality of stakeholders approves the image.

9. The system of claim 8,
wherein at least one of the plurality of stakeholders comprises multiple stakeholder members.

10. The system of claim 9, and
wherein the vote of the at least on stakeholder is one selected from the group consisting of a majority vote, a consensus vote, a minimum approval vote, and a requisite approval vote by the multiple stakeholder members.

11. The system of claim 8, wherein the vote is based on a testing of the image.

12. The system of claim 11, wherein the vote is automatically submitted after the testing of the image, without human involvement.

13. The system of claim 11,
wherein the vote is automatically submitted after the testing of the image, without human involvement, if the image passes the test, and
wherein the vote is manually submitted after the testing of the image, if the image fails the test.

14. The system of claim 8, wherein the instructions further cause the system to: generate a documentation of the image, the documentation included in the image released for deployment.

15. A non-transitory computer readable medium comprising computer readable program code causing a computer system to:
obtain an image to be reviewed;
identify a plurality of stakeholders associated with the image;
iteratively perform a review of the image by the plurality of stakeholders to obtain an approval of the image by:
sequentially obtaining a vote on the image from each stakeholder of the plurality of stakeholders;
discontinuing the sequential obtaining of the vote if one of the plurality of stakeholders votes to reject the image; and
release the image for deployment if the vote of each stakeholder in the plurality of stakeholders approves the image.

16. The non-transitory computer readable medium of claim 15,
wherein at least one of the plurality of stakeholders comprises multiple stakeholder members.

17. The non-transitory computer readable medium of claim 16, and
wherein the vote of the at least on stakeholder is one selected from the group consisting of a majority vote, a consensus vote, a minimum approval vote, and a requisite approval vote by the multiple stakeholder members.

18. The non-transitory computer readable medium of claim 15, wherein the vote is based on a testing of the image.

19. The non-transitory computer readable medium of claim 18, wherein the vote is automatically submitted after the testing of the image, without human involvement.

20. The non-transitory computer readable medium of claim 18,
wherein the vote is automatically submitted after the testing of the image, without human involvement, if the image passes the test, and
wherein the vote is manually submitted after the testing of the image, if the image fails the test.
